(19) United States
(12) Patent Application Publication
(10) Pub. No.: US 2006/0061006 A1
(43) Pub. Date: Mar. 23, 2006

(54) Device for producing filaments from thermoplastic synthetic

(75) Inventors: Detlef Frey, Niederkassel (DE); Hans-Georg Geus, Niederkassel (DE); Michael Latinski, Duisburg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: REIFENHAEUSER GMBH & CO. KG MASCHINENFABRIK, Troisdorf (DE)

(21) Appl. No.: 11/226,231

(22) Filed: Sep. 15, 2005

(30) Foreign Application Priority Data
Sep. 17, 2004 (DE) 04022248.1

(51) Int. Cl. B29C 47/60

(52) U.S. Cl. 264/211.22; 425/72.2

(57) ABSTRACT

Device for producing filaments from thermoplastic synthetic, with a meltblown die head, which as a guiding core with at least one row of orifices for the discharge of molten synthetic, one or more feed devices for primary blown air on both sides of the synthetic guiding core with which the filaments in the region of the apertures of the orifices can be subjected to primary blown air on both sides, and at least one feed device for secondary blown air with which the filaments can be subjected to secondary blown air sideways beneath the meltblown die head.

### SUMMARY OF THE BACKGROUND

1. Field of the Invention

The invention relates to a device for producing filaments from synthetic material thermoplastic with a meltblown die head which has a thermoplastic material guiding core with at least one row of orifices for the discharge of the molten synthetic, and which also has feed devices positioned on both sides of the guiding core for primary blown air of the filaments on both sides. A process of producing endless filaments with the device is also included in the invention. The invention further relates to a process of depositing filaments on a depositing device to form a nonwoven web or meltblown web, and the meltblown webs produced with this process, and filters containing the webs.

2. Description of the Related Art

Devices which were previously used to form filaments of thermoplastic resin are limited to forming filaments of 1 μm or larger diameter. A significant reduction of these filament diameters gives rise to difficulties. Changing or controlling the quantity of air, the speed and the temperature of the primary blown air used during the forming of the filaments to reduce the filament diameter is possible. However, these measures have not lead to satisfactory results. Very small filament diameters or filament diameters which are significantly less than 1 μm would be very advantageous for the production of meltblown webs for use in filters and fine filters.

### SUMMARY OF THE INVENTION

Accordingly, a technical problem which is addressed in one aspect of the invention is to provide a device for producing filaments from synthetic material thermoplastic with a meltblown die head which has a thermoplastic material guiding core with at least one row of orifices for the discharge of the molten synthetic, and which also has feed devices positioned on both sides of the guiding core with which, in a simple and functionally reliable way, the filament diameter can be effectively reduced so that diameters less than 1 μm and in particular also considerably less than 1 μm such as 0.9, 0.8, 0.7, 0.6, 0.5, 0.4, 0.3, 0.2, and 0.1 mm, can be achieved.

In order to solve this technical problem, the invention includes a device for producing filaments from thermoplastic synthetic, comprising at least (i) a meltdown die head, which has a guiding core with at least one row of orifices for the discharge of the molten synthetic thermoplastic material, and which furthermore has (ii) feed devices for providing primary blown air located on both sides of the guiding core, with which the filaments can be subjected to primary blown air on both sides in the region of the apertures of the orifices, and (iii) at least one feed device for providing secondary blown air, with which the filaments below the meltblown die head can be subjected to secondary blown air at a temperature of more than 50° C., sideways, or from the side.

### BRIEF DESCRIPTION OF THE DRAWINGS

FIG. 1 shows a device for producing filaments.

### DETAILED DESCRIPTION OF THE INVENTION

In one aspect, the invention includes a device for producing filaments from a synthetic thermoplastic material. In one embodiment the device includes a meltdown die head and a feed device. The meltdown die head has a guiding core with at least one row of orifices for the discharge of molten synthetic thermoplastic material. The device includes at least one feed device for primary blown air located on both sides of the guiding core and by which filaments can be subjected to blown air on both sides in the region of the apertures of the orifices. The device also includes a feed device for providing secondary blown art to permit filaments below the meltdown die head to be subjected to secondary blown air at a temperature of more than 50° C. in a sideways orientation or from the side.

The discharge of the molten synthetic thermoplastic material or molten polymer through the orifices of the guiding core may take place in the form of flows of synthetic thermoplastic material, which at the same time form the filaments. The primary blown air and the jets of primary blown air are advantageously directed at acute angles to one another beneath the orifices. It is within the framework of the invention that the primary blown air is fed in through corresponding gaps on the guiding core in the form of blown air surface jets.

Advantageously, the primary blown air is fed in on both sides through gaps or channels between the synthetic guiding core and die lips, and preferably the gap width of the gaps can be adjusted. Beneath the synthetic guiding core there are therefore advantageously two die lips positioned opposite one another, which are preferably adjustable so that the gap width of the gaps can be adjusted between the guiding core and the die lips. Moreover, the distance x between the synthetic guiding core point and the (supposed) horizontal extension of the die lip point can advantageously be adjusted.

According to the invention, secondary blown air is also blown in beneath the meltblown die head from the side onto the filaments or onto the filament curtain. It is within the framework of the invention that the secondary blown air can be blown in at an angle α of from 50° to 90°, preferably from 65° to 90°, and ideally from 75° to 90° to a supposed straight line or vertical running through a spray hole, sideways or from the side. The angle α is therefore at the same time the angle between a jet of secondary blown air and the aforementioned supposed straight line or vertical. The jets of secondary blown air can therefore be blown in at an angle α to supposed straight lines and verticals running through the orifices onto the filaments exiting through these orifices. It is within the framework of the invention that the direction of the supposed straight lines corresponds to the primary (non-deflected) exit direction of the filaments from the orifices.

According to a particularly preferred embodiment of the invention, the secondary blown air can be blown in orthogonally or essentially orthogonally to a supposed straight line or vertical running through an orifice. Essentially orthogonally means that the angle α is 80° to 90°, and preferably 85° to 90°. It is within the framework of the invention that the secondary blown air is blown in at a higher speed onto the filaments or onto the filament curtain. In this way, according to the invention, the vibrations of the filaments and the fibers are increased, both in their frequency and in their amplitude. In this respect, additional elongation points or additional fibre treatment points can be produced so that very effective and extensive elongation of the filaments is possible.

It is within the framework of the invention that the at least one feed device for the secondary blown air is set up with the proviso that secondary air with a temperature of more than 50° C., preferably with a temperature of more than 60° C. can be blown in. Especially favoured is a secondary blown air temperature of between 65° C. and 90° C., and very much favoured, between 70° C. and 80° C. Preferably, the warmed up secondary blown air has a relative air humidity of less than 70%, preferably less than 50%, and very preferably, less than 20%. By blowing in the warm or hot secondary blown air, the thermoplastic phase of the filaments is at the same time extended, so that the filaments can remain extensible for a long time along their path. In this way very effective elongation is achieved.

According to a particularly preferred embodiment of the invention, feed devices for the secondary blown air are arranged with the proviso that the filaments or the filament curtain can be subjected to secondary blown air from both sides. Advantageously, feed devices are therefore provided on both sides of the filament curtain so that it is possible to subject the filament curtain to secondary blown air on both sides.

According to one embodiment of the invention, the subjection to secondary blown air from at least one side of the filaments or of the filament curtain is constant over time. Subjection to blown air which is constant over time here means in particular that the blowing speed of the secondary blown air remains constant over time. According to this embodiment, the blowing with the secondary blown air preferably happens constantly over time from both sides of the filaments or the filament curtain.

According to another embodiment of the invention, the subjection to the secondary blown air happens pulsatingly from at least one side of the filaments or the filament curtain (ie. not constant over time). Pulsating blowing means here in particular that the blowing speed of the secondary blown air changes over the course of time. Here, the speed of the secondary blown air can for example change, pulsating or alternating between 0 and a speed value of v1.

It is within the framework of the invention that the device according to the invention has a depositing device onto which the filaments can be deposited as a nonwoven web or meltblown web. The meltblown web produced in this way is used, according to a highly favoured embodiment of the invention, as filters or in filters, and in particular in fine filters.

Moreover, the subject matter of the invention is also a method for producing the filaments from thermoplastic synthetic, where—as described—one works both with primary blown air blowing and secondary blown air blowing. Furthermore, the subject matter of the invention is the use of the filaments or of a meltblown web produced with the filaments as a filter material.

A device according to the invention or with the corresponding method according to the invention, may be used to produce filaments characterised by a surprisingly small diameter. Filaments with a filament diameter of less than 1 μm and also with a filament diameter of significantly less than 1 μm can be produced without any problem. Furthermore, the embodiment including blowing in secondary blown air can effectively stimulate the filaments to vibrate more, and in this way, the number of elongation points or elongation regions is effectively increased. In combination with this is the particular significance of the blowing of secondary blown air of a higher temperature, because in this way, the thermoplastic phase of the filaments can be effectively extended. As a result, by means of the effective additional elongations, a surprisingly large reduction of the filament diameter is at the same time achieved in comparison with previously known measures. These filaments with a very small diameter can be deposited as meltblown webs, which can be used as high-performance filters or fine filters with a high collection efficiency with low pressure loss. In particular, previously known glass fibre filters can be replaced by meltblown webs produced according to the invention.

In the following, the invention is described in greater detail using a drawing showing just one example of an embodiment. The one Figure shows in the form of a schematic representation a section through a device according to the invention.

A device is shown for producing filaments 1 from thermoplastic synthetic, the device having a meltblown die head 2. The meltblown die head 2 is equipped with a guiding core 3 which, in the embodiment given as an example, has a row of orifices 4 for the discharge of the molten synthetic thermoplastic material. The row of orifices 4 extends perpendicularly to the level of the paper.

On both sides of the guiding core 3 there are feed devices (not shown in detail) with which the filaments 1 can be subjected to the primary blown air on both sides in the region of the apertures of the orifices 4. The subjection to primary blown air on both sides is shown by the two arrows A in the example of an embodiment. It can be seen in the Figure that the primary blown air and the primary blown air surface jets are directed at acute angles to one another beneath the orifices 4. The primary blown air is fed on both sides through gaps 5 between the guiding core 3 and the die lips 6. Advantageously, the die lips 6 here are adjustable so that the gap width w can be adjusted. Preferably, and in the example of the embodiment, the distance x between the point of the guiding core 3 and the horizontal extension of the die lip points is also adjustable.

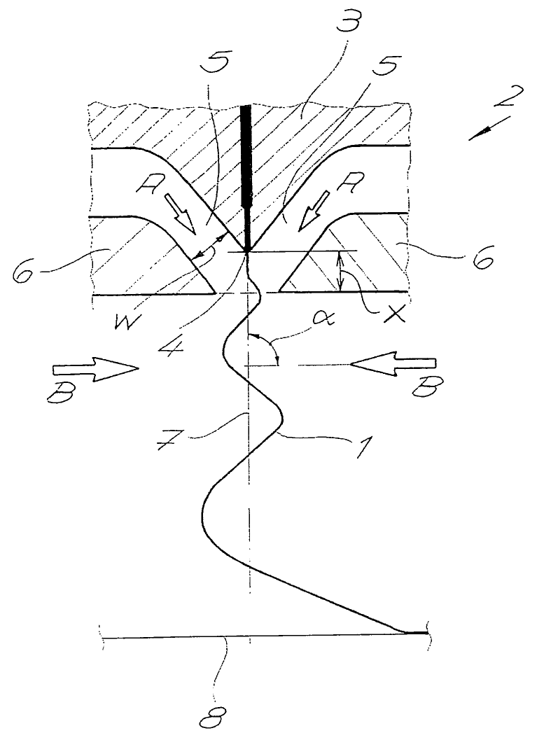

Device for providing secondary blown air may be formed in the die lips 6 shown in FIG. 1. In another embodiment the secondary blown air is provided by one or more devices that may be fixedly attached, removable or integral with the guiding core 3.

According to the invention, on both sides of the filament curtain from the filaments 1, feed devices for secondary blown air (not shown in detail) are provided with which the filaments are subjected to secondary blown air sideways beneath the meltblown die head 2. This subjection to secondary blown air is shown by the arrows B in the Figure. Furthermore, it can be seen in the figure that, according to the preferred embodiment of the invention, the secondary blown air can be blown in orthogonally, or essentially orthogonally, to the supposed straight line 7 running through the orifices 4. The angle α between the secondary blown air blown in or between a jet of secondary blown air and a straight line 7 is therefore 90° or approximately 90°. It is indicated in the Figure that, due to the blowing in of secondary air at high speed, vibration of the filaments 1 is effectively increased. In this way, additional elongation points or fibre treatment points on the filaments are created.

In the example of an embodiment, and according to a very preferred embodiment, the temperature of the secondary blown air is 65° C. to 85° C., preferably 70° C. to 80° C.

In the example of an embodiment, beneath the meltblown die head 2 and beneath the secondary blown air blown in there is a depositing device 8 which preferably and in the embodiment given as an example is in the form of a filter band. On this depositing device 8, the filaments are advantageously deposited as meltblown web (not shown). The meltblown web is particularly suitable for filter applications.

Obviously, numerous modifications and variations of the present invention are possible in light of the above teachings. It is therefore to be understood that within the scope of the appended claims, the invention may be practiced otherwise than as specifically described herein.

European patent application 04022248.1, filed on Sep. 17, 2004 is incorporated herein by reference in its entirety.

1. A device for producing filaments from a synthetic thermoplastic material, comprising:
a meltblown die head having a guiding core having at least one row of orifices for the discharge of the synthetic thermoplastic material in molten form;
one or more primary blown air feed devices positioned on both sides of the guiding core and configured to blow the filaments on both sides with primary blown air in the region of the apertures of the orifices; and
at least one secondary blown air feed device positioned beneath the meltblown die head and configured to blow the filaments sideways with secondary blown air at a temperature of more than 50° C.

2. The device according to claim 1, further comprising:
one or more of a gap and a die lip, wherein the die lip is connected to the meltblown die head and the gap is located between the guiding core and the die lip,
wherein the gap width w of the gap and the distance x between the guiding core and a horizontal extension of a die lip is adjustable.

3. The device according to claim 1, wherein the primary blown air feed devices are configured to blow the primary air at an angle α of from 50 to 90° relative to a straight line defined by the orifices in the meltblown die head.

4. The device according to claim 3, wherein a is from 65 to 90°.

5. The device according to claim 3, wherein a is from 75 to 90°.

6. The device according to claim 3, wherein the secondary blown air feed device is capable of blowing secondary air essentially orthogonally to a straight line defined by an orifice in the meltblown die head

7. The device according to claim 6, wherein the secondary blown air feed device is capable of blowing secondary air orthogonally to a straight line defined by an orifice in the meltblown die head.

8. The device according to claim 1, wherein the secondary blown air feed device is capable of blowing secondary air at a temperature of more than 60° C.

9. The device according to claim 1, wherein the secondary blown air feed device is capable of blowing secondary air having a humidity of less than 70%.

10. The device according to claim 9, wherein the secondary blown air feed device is capable of blowing secondary air having a humidity of less than 50%.

11. The device according to claim 9, wherein the secondary blown air feed device is capable of blowing secondary air having a humidity of less than 20%.

12. The device according to claim 1, comprising at least one secondary blown air feed device capable of blowing the filaments with secondary blown air from a first side and second side.

13. The device according to claim 12, wherein the first and second sides face one another.

14. The device according to claim 1, further comprising:
a depositing device for depositing the filaments as a nonwoven web.

15. A method, comprising:
passing a molten synthetic thermoplastic material through a meltblown die head having a guiding core having at least one row of orifices;
after passing through the guiding core, blowing the molten synthetic thermoplastic material with air from one or more primary blown air feed devices proximate to the apertures of the orifices of the guiding core; and
blowing the filaments sideways with air from one or more secondary blown air feed devices positioned beneath the meltdown die head with air at a temperature of more than 50° C.

16. The method according to claim 15, wherein the filaments are blown by the secondary blown air feed device at a constant rate from at least one side of the filaments.

17. The method according to claim 15, wherein filaments are blown with the secondary blown air feed device by pulsating the secondary blown air from at least one side of the filaments.

18. The method according to claim 15, further comprising:
depositing the blown filaments on a depositing device to form a nonwoven web.

19. The method according to claim 15, wherein filaments are blown with secondary blown air having a humidity of less than 70%.

20. The method according to claim 15, wherein the filaments are blown with secondary blown air having a humidity of less than 50%.

21. The method according to claim 15, wherein the filaments are blown with secondary blown air having a humidity of less than 20%.

22. The method according to claim 15, wherein filaments are blown with secondary blown air having a temperature of more than 60° C.

23. The method according to claim 15, wherein the filaments are blown with secondary blown air blown at an angle α of from 50 to 90° C. relative to a straight line defined by the orifices of the meltblown die head.
